(19) United States
(12) Patent Application Publication
(10) Pub. No.: US 2025/0113118 A1
(43) Pub. Date: Apr. 3, 2025

(54) PHOTOELECTRIC CONVERSION DEVICE, PHOTOELECTRIC CONVERSION SYSTEM, AND MOVING BODY

(71) Applicant: CANON KABUSHIKI KAISHA, Tokyo (JP)

(72) Inventor: HIROSHI SEKINE, Kanagawa (JP)

(21) Appl. No.: 18/898,176

(22) Filed: Sep. 26, 2024

(30) Foreign Application Priority Data
Sep. 28, 2023 (JP) 2023-168620

(51) Int. Cl. H04N 25/779; H04N 25/771; H04N 25/773

(52) U.S. Cl. CPC H04N 25/779; H04N 25/771; H04N 25/773

(57) ABSTRACT

A device includes a plurality of pixels, each of the plurality of pixels including an avalanche photodiode, a counting circuit configured to count a number of photons which have entered the avalanche photodiode within an exposure period, a memory connected to the counting circuit, a first switch arranged between the counting circuit and the memory, and a comparison circuit connected to the counting circuit and the memory, wherein the first switch switches between connection and disconnection between the counting circuit and the memory according to a detection signal that is based on a signal output from the comparison circuit.

### BACKGROUND

### Technical Field

The aspect of the embodiments generally relates to a photoelectric conversion device, a photoelectric conversion system, and a moving body.

### Description of the Related Art

Known photoelectric conversion devices include a photoelectric conversion device in which pixels each including a plurality of avalanche photodiodes (APDs) are arranged. This photoelectric conversion device is enabled to perform photodetection in the level of a single photon using each pixel with use of a phenomenon in which electric charge generated by photons entering APDs causes avalanche multiplication (avalanche breakdown).

Japanese Patent Application Laid-Open No. 2020-96347 discusses an image sensor including detection elements, each of which detects the presence or absence of an address-event, counting pixels, each of which detects the number of photons having entered the pixel within a predetermined exposure period in a case where the above-mentioned address-event has occurred, and a control method for such an image sensor.

In the image sensor discussed in Japanese Patent Application Laid-Open No. 2020-96347, since address-event detection pixels and counting pixels are arranged at respective different predetermined addresses and are arranged separately with respect to respective functions thereof, it is impossible to acquire both counting information and event information with use of signals output from the same pixel.

### SUMMARY

According to an aspect of the embodiments, a device includes a plurality of pixels, each of the plurality of pixels including an avalanche photodiode, a counting circuit configured to count a number of photons which have entered the avalanche photodiode within an exposure period, a memory connected to the counting circuit, a first switch arranged between the counting circuit and the memory, and a comparison circuit connected to the counting circuit and the memory, wherein the first switch switches between connection and disconnection between the counting circuit and the memory according to a detection signal that is based on a signal output from the comparison circuit.

Further features of the disclosure will become apparent from the following description of exemplary embodiments with reference to the attached drawings.

### BRIEF DESCRIPTION OF THE DRAWINGS

FIG. 1 is a diagram illustrating a configuration of a photoelectric conversion device according to a first exemplary embodiment.

FIG. 2 is a diagram illustrating the arrangement of a pixel substrate of the photoelectric conversion device according to the first exemplary embodiment.

FIG. 3 is a diagram illustrating a configuration of a circuit substrate of the photoelectric conversion device according to the first exemplary embodiment.

FIG. 4 is a block diagram of one pixel in the pixel substrate and the circuit substrate according to the first exemplary embodiment.

FIGS. 5A, 5B, and 5C are schematic diagrams illustrating driving of a pixel circuit of the photoelectric conversion device according to the first exemplary embodiment.

FIG. 6 is a flowchart illustrating an example of an operation of the photoelectric conversion device according to the first exemplary embodiment.

FIG. 7 is a diagram illustrating a configuration example of a pixel circuit of a photoelectric conversion device according to a second exemplary embodiment.

FIG. 8 is a flowchart illustrating an example of an operation of the photoelectric conversion device according to the second exemplary embodiment.

FIG. 9 is a functional block diagram of a photoelectric conversion system according to a third exemplary embodiment.

FIGS. 10A and 10B are functional block diagrams of a photoelectric conversion system according to a fourth exemplary embodiment.

FIG. 11 is a functional block diagram of a photoelectric conversion system according to a fifth exemplary embodiment.

FIG. 12 is a functional block diagram of a photoelectric conversion system according to a sixth exemplary embodiment.

FIGS. 13A and 13B are functional block diagrams of a photoelectric conversion system according to a seventh exemplary embodiment.

FIGS. 14A and 14B are functional block diagrams of a photoelectric conversion system according to an eighth exemplary embodiment.

FIG. 15 is a functional block diagram of a photoelectric conversion system according to a ninth exemplary embodiment.

### DESCRIPTION OF THE EMBODIMENTS

The following exemplary embodiments are intended to embody a technological thought of the disclosure and should not be construed to limit the disclosure. The sizes and relationships of members illustrated in the respective drawings may be exaggerated for illustrative purposes. In the following description, the same constituent elements are assigned the respective same reference characters and any repetitive description thereof may be omitted as appropriate.

Various exemplary embodiments, features, and aspects of the disclosure will be described in detail below with reference to the drawings. Furthermore, in the following description, terms representing specific directions or positions (for example, “up”, “upward”, “above”, “over”, “down”, “downward”, “below”, “under”, “right”, “rightward”, “left”, and “leftward”) are used as needed. Using such terms are intended to facilitate understanding of each exemplary embodiment by referring to the drawings, and the technical scope of the disclosure should not be construed to be limited by the meanings of such terms.

In the present specification, the term “planar view” refers to being viewed from a direction perpendicular to a light entrance surface of a semiconductor layer. Moreover, the term “cross-sectional view” refers to viewing a cross-section perpendicular to the light entrance surface of the semiconductor layer. Furthermore, in a case where the light entrance surface of the semiconductor layer is a coarse surface as seen in the microscopic sense, the planar view is defined based on the light entrance surface of the semiconductor layer as seen in the macroscopic sense.

The semiconductor layer includes a first surface and a second surface, which is a surface opposite to the first surface and on which light is incident.

In the present specification, the depth direction is a direction leading from the first surface to the second surface of a semiconductor layer in which avalanche photodiodes (APDs) are arranged. In the following description, the “first surface” may be referred to as a “front surface”, and the “second surface” may be referred to as a “back surface”.

In the following description, the anode of an APD is set to fixed electric potential and a signal is taken out from the cathode thereof. Accordingly, a semiconductor region of the first conductivity type, in which electric charge equal in polarity to signal charge is set as a majority carrier, is an N-type semiconductor region, and a semiconductor region of the second conductivity type, in which electric charge different in polarity from signal charge is set as a majority carrier, is a P-type semiconductor region. Furthermore, the disclosure can be applied even to a case where the cathode of an APD is set to fixed electric potential and a signal is taken out from the anode thereof. In this case, a semiconductor region of the first conductivity type, in which electric charge equal in polarity to signal charge is set as a majority carrier, is a P-type semiconductor region, and a semiconductor region of the second conductivity type, in which electric charge different in polarity from signal charge is set as a majority carrier, is an N-type semiconductor region. While, in the following description, an example in which one of the nodes of an APD is set to fixed electric potential is described, the electric potentials of both nodes can be configured to vary.

Moreover, in the following exemplary embodiments, there is a case where connection between circuit elements is mentioned. In this case, even if another element intervenes between elements of interest, unless otherwise described, the elements of interest are treated as being connected to each other. For example, suppose that an element A is connected to one node of a capacitive element C, which has a plurality of nodes, and an element B is connected to the other node of the capacitive element C. Even in such a case, unless otherwise described, the element A and the element B are treated as being connected to each other.

Each metallic member, such as a wiring or a pad, described in the present specification can be configured with a single body of metal of a given element or can be a mixture (alloy). For example, a wiring which is described as a copper wiring can be configured with a single body of copper or can be a configuration principally containing copper and further containing another component. Moreover, for example, a pad which is connected to an external terminal can be configured with a single body of aluminum or can be a configuration principally containing aluminum and further containing another component. A copper wiring or an aluminum pad mentioned here is merely an example, and can be changed to a variety of metals.

Moreover, a wiring or a pad mentioned here is merely an example of a metallic member, and another type of metallic member can also be used.

In each exemplary embodiment described below, an example of a photoelectric conversion device is described with a focus on an image capturing device. However, each exemplary embodiment is not limited to an image capturing device, but can also be applied to another example of a photoelectric conversion device. For example, each exemplary embodiment can also be applied to a distance measuring device (a device for, for example, focus detection or distance measurement using time of flight (ToF)) or a light metering device (a device for, for example, metering the amount of incident light).

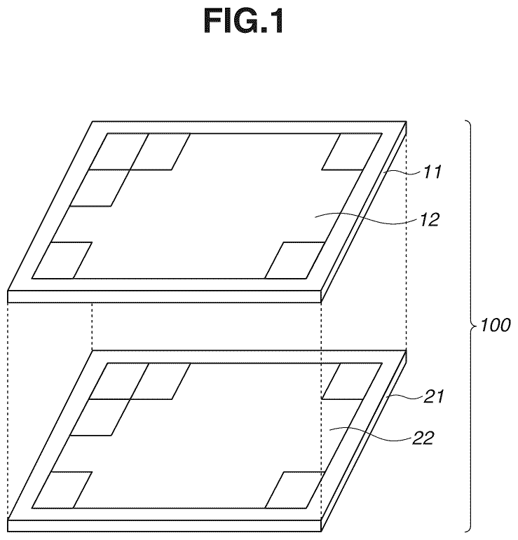

A photoelectric conversion device and an operation flow thereof in a first exemplary embodiment are described with reference to FIG. 1 to FIG. 6.

FIG. 1 is a diagram illustrating a configuration of a photoelectric conversion device 100 in the first exemplary embodiment. In the following description, a case where the photoelectric conversion device 100 is a stacked photoelectric conversion device is described by way of example. Thus, a photoelectric conversion device which is configured by two substrates, i.e., a pixel substrate 11 and a circuit substrate 21, being stacked on each other and being electrically connected to each other is described as an example. However, the photoelectric conversion device is not limited to this. For example, a photoelectric conversion device in which a configuration included in the pixel substrate 11 and a configuration included in the circuit substrate 21 are arranged in a common semiconductor layer, which is described below, can be employed. In the following description, the photoelectric conversion device in which a configuration included in the pixel substrate 11 and a configuration included in the circuit substrate 21 are arranged in a common semiconductor layer is also referred to as a “non-stacked photoelectric conversion device”.

The pixel substrate 11 includes a first semiconductor layer, which includes photoelectric conversion portions 102 described below, and a first wiring structure. The circuit substrate 21 includes a second semiconductor layer, which includes circuits such as signal processing portions 103 described below, and a second wiring structure. The photoelectric conversion device 100 is configured with the second semiconductor layer, the second wiring structure, the first wiring structure, and the first semiconductor layer being stacked one after another in this order.

FIG. 1 illustrates a back-illuminated type stacked photoelectric conversion device, in which light falls on the second surface of the first semiconductor layer of the pixel substrate 11 and the circuit substrate 21 is arranged on the side of the first surface of the first semiconductor layer, which is a surface opposite to the second surface.

In the case of a non-stacked photoelectric conversion device, a surface on which a transistor of the signal processing portion of a semiconductor layer is arranged is referred to as a “first surface”. In the case of a back-illuminated photoelectric conversion device, the second surface opposite to the first surface of the semiconductor layer serves as a light entrance surface. Moreover, in the case of a front-illuminated photoelectric conversion device, the first surface of the semiconductor layer serves a light entrance surface.

While, in the following description, each of the pixel substrate 11 and the circuit substrate 21 is described with a diced chip, each substrate is not limited to a chip. For example, each substrate can be a wafer. Moreover, each substrate can be a chip obtained by dicing semiconductors stacked in a wafer state, or can be obtained by chipping semiconductors into chips and stacking and joining the chips. Moreover, a semiconductor layer obtained by a semiconductor layer brought into the state of being thinned from the state of a substrate and a wiring structure being stacked each other is also referred to as a “substrate” in the present specification.

The pixel substrate 11 has a pixel region 12 arranged thereon, and the circuit substrate 21 has a circuit region 22, which processes a signal detected by the pixel region 12, arranged thereon.

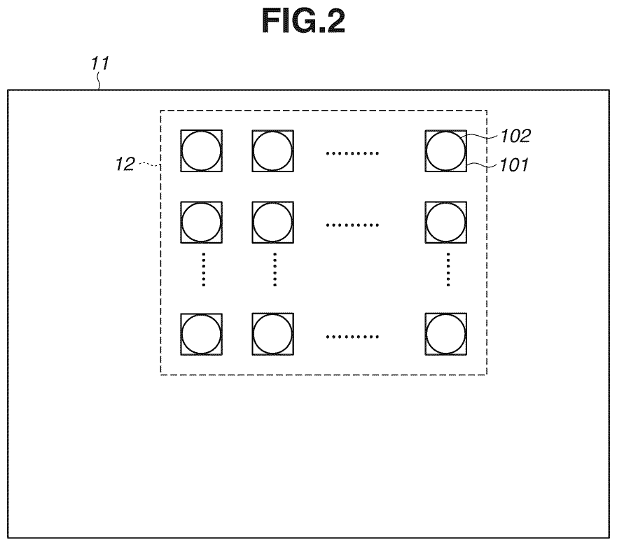

FIG. 2 is a diagram illustrating an arrangement of the pixel substrate 11. In the pixel substrate 11, a plurality of pixels 101, each of which includes a photoelectric conversion portion 102 including an avalanche photodiode (APD), is arranged in a two-dimensional form, thus forming the pixel region 12. In other words, some APDs of a plurality of APDs are arranged in a predetermined direction (for example, row direction). Moreover, some APDs of a plurality of APDs are arranged in a direction perpendicular to the predetermined direction (for example, column direction). In this way, it is favorable that the pixels 101 are arranged in in a two-dimensional array form.

While, typically, the pixel 101 is a pixel for forming an image, in the case of being used for Time of Flight (TOF), the pixel 101 does not necessarily need to form an image. Thus, the pixel 101 can be a pixel for measuring the time of arrival of light and the amount of light.

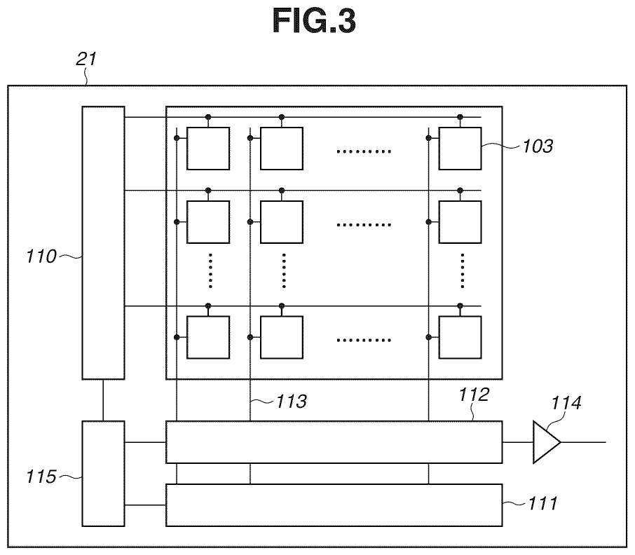

FIG. 3 is a configuration diagram of the circuit substrate 21. The circuit substrate 21 includes signal processing portions 103, each of which processes electric charge obtained by photoelectric conversion performed by the photoelectric conversion portion 102 illustrated in FIG. 2, a readout circuit 112, a control pulse generation portion 115, a horizontal scanning circuit portion 111, signal lines 113, and a vertical scanning circuit portion 110.

The photoelectric conversion portion 102 illustrated in FIG. 2 and the signal processing portion 103 illustrated in FIG. 3 are electrically interconnected via a connection wiring provided for each pixel.

The vertical scanning circuit portion 110 receives a control pulse signal supplied from the control pulse generation portion 115 and supplies a control pulse signal to each pixel. The vertical scanning circuit portion 110 to be used is a logic circuit such as a shift register or an address decoder.

The control pulse generation portion 115 includes a signal generation portion, which generates a control signal for a switch 202 described below. The signal generation portion generates a pulse signal for controlling the switch 202 as described below. Furthermore, the signal generation portion can be configured to generate a control signal with respect to all of the pixels of a plurality of pixels included in a pixel region, or can be configured to generate a control signal in common with respect to some pixels of a plurality of pixels included in a pixel region. In the case of generating a pulse signal in common, the signal generation portion associates at least one of a signal P_EXP for controlling an exposure period, the period of a pulse signal, the number of pulses, and the pulse width with an exposure period to generate a pulse signal in common. Moreover, in the case of generating a control signal in common with respect to some pixels, the signal generation portion is able to generate a control signal with use of both an input signal VR_IN output from the control pulse generation portion 115 and a signal P_EXP for controlling an exposure period. It is favorable that the control pulse generation portion 115 includes, for example, a frequency dividing circuit. This enables performing simple control, thus preventing the number of elements from increasing. A pulse signal is supplied from the control pulse generation portion 115.

A signal output from the photoelectric conversion portion 102 of each pixel is processed by the signal processing portion 103. The signal processing portion 103 is provided with, for example, a photon counting circuit (hereinafter also referred to as a “counter”), which counts the number of photons which have entered the pixel within a predetermined exposure period, and a memory. A digital value is retained in the memory.

To read out a signal from the memory of each pixel in which a digital signal is retained, the horizontal scanning circuit portion 111 inputs, to the signal processing portion 103, a control pulse signal for sequentially selecting each column.

To the signal line 113, with respect to the selected column, a signal is output from the signal processing portion 103 of a pixel selected by the vertical scanning circuit portion 110. The signal line 113 is connected to each of the pixels arranged side by side in the column direction and serves as an output line in common for these pixels.

The signal output to the signal line 113 is output, via an output circuit 114, to a recording unit or signal processing unit on the outside of the photoelectric conversion device 100.

In FIG. 2, the arrangement of a plurality of pixels in the pixel region 12 can be a one-dimensional form. The function of the signal processing portion 103 does not necessarily need to be provided one by one in each of all the pixels 101, and, for example, one signal processing portion 103 can be shared by photoelectric conversion portions 102 of a plurality of pixels 101 to sequentially perform signal processing operations on outputs from the photoelectric conversion portions of the respective pixels 101.

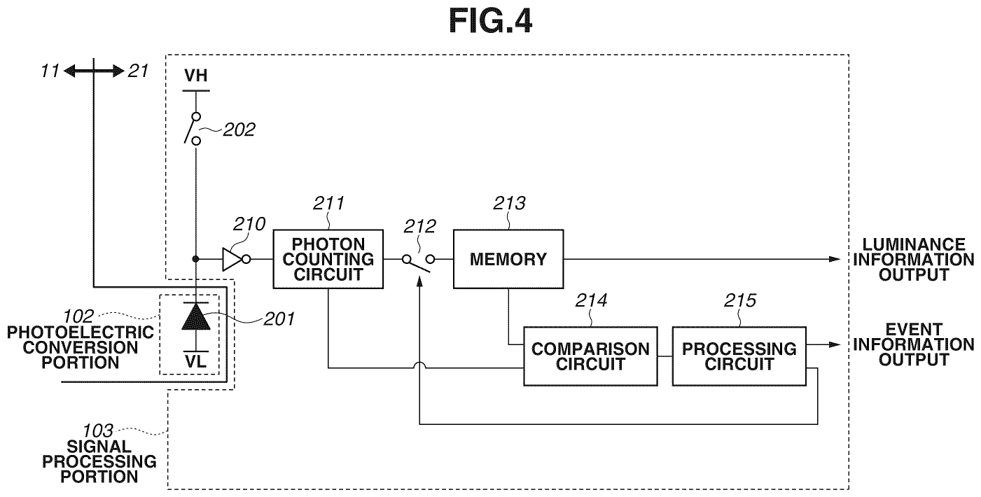

FIG. 4 is a block diagram including illustration of an example of an equivalent circuit of the pixel 101 illustrated in FIG. 2 and FIG. 3. Referring to FIG. 4, the photoelectric conversion portion 102, which includes an APD 201, is provided in the pixel substrate 11, and the other members are provided in the circuit substrate 21. According to the configuration of the pixel illustrated in FIG. 4, it becomes possible to obtain both luminance information (counting information) and event information from one pixel by a photon counting operation.

The APD 201 generates an electric charge pair corresponding to incident light by photoelectric conversion. The APD 201 includes a first terminal and a second terminal. The first terminal is, for example, a cathode, and the second terminal is, for example, an anode. A voltage VL (first voltage) is supplied to the anode of the APD 201. Moreover, a voltage VH (second voltage) higher than the voltage VL, which is supplied to the anode, is supplied to the cathode of the APD 201. A reverse bias voltage is supplied to the anode and cathode of the APD 201 in such a way as to cause the APD 201 to perform an avalanche multiplication operation. In response to the APD 201 being brought into the state of being supplied with such a voltage, electric charge caused by incident light brings about avalanche multiplication, thus generating avalanche current.

Furthermore, in a case where a reverse bias voltage is supplied, there are a Geiger mode for causing the APD to operate with an electric potential difference between the anode and the cathode which is greater than the breakdown voltage and a linear mode for causing the APD to operate with an electric potential difference between the anode and the cathode which is close to the breakdown voltage or less than or equal to the breakdown voltage. The APD which is caused to operate in the Geiger mode is referred to as a “single photon avalanche diode (SPAD)”. For example, the voltage VL (first voltage) is −30 volts (V), and the voltage VH (second voltage) is 1 V. The APD 201 can be caused to operate in the linear mode or can be caused to operate in the Geiger mode.

The switch 202 is connected to a control line to which the drive voltage VH is supplied and the APD 201. The switch 202 is connected to one node included in the anode and the cathode of the APD 201.

Then, the switch 202 switches the electric potential difference between the anode and cathode of the APD 201 between a first electric potential difference, which brings about avalanche multiplication, and a second electric potential difference, which does not bring about avalanche multiplication. In the following description, switching from the second electric potential difference to the first electric potential difference is also referred to as “turning-on of the switch 202”, and switching from the first electric potential difference to the second electric potential difference is also referred to as “turning-off of the switch 202”. The switch 202 serves as a quench element. The switch 202 functions as a load circuit (quench circuit) at the time of signal multiplication caused by avalanche multiplication, and has the action of reducing the voltage to be supplied to the APD 201 and thus preventing or reducing avalanche multiplication (quench operation). Moreover, the switch 202 has the action of causing a current corresponding to a voltage drop caused by the quench operation to flow and thus returning the voltage to be supplied to the APD 201 to the drive voltage VH (recharge operation). Thus, the switch 202 serves as a control circuit which controls the occurrence of avalanche multiplication in the APD 201.

The switch 202 is able to be configured with, for example, a metal-oxide semiconductor (MOS) transistor. A control signal is supplied from the signal generation portion to the gate electrode of the switch 202. In the first exemplary embodiment, controlling an applied voltage to the gate electrode of the switch 202 is used to control turning-on and turning-off of the switch 202.

The signal processing portion 103 includes a waveform shaping portion 210, a photon counting circuit (counter circuit) 211, a memory 213, a comparison circuit 214, a processing circuit 215, and a switch 212. In the first exemplary embodiment, the signal processing portion 103 includes the photon counting circuit 211, the memory 213, and the comparison circuit 214.

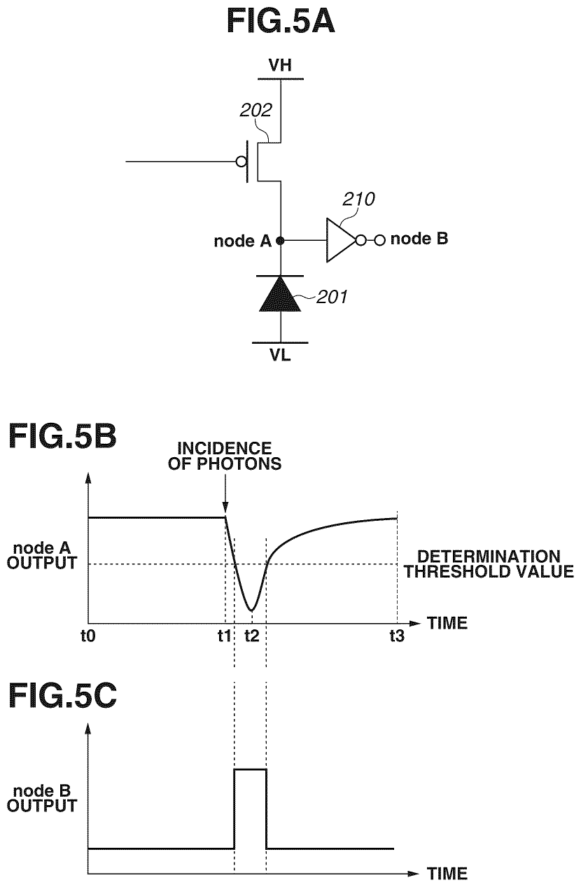

The waveform shaping portion 210 shapes a change in electric potential of the cathode of the APD 201 which is obtained at the time of detection of photons, and thus outputs a pulse signal. The node on the input side of the waveform shaping portion 210 is referred to “node A”, and the node on the output side of the waveform shaping portion 210 is referred to “node B”. The waveform shaping portion 210 210 varies an output electric potential from the node B depending on whether the input electric potential to the node A is higher than or equal to a predetermined value or is lower than the predetermined value. For example, referring to FIGS. 5A, 5B, and 5C, when the input electric potential to the node A becomes a high electric potential higher than or equal to a determination threshold value, the output electric potential from the node B becomes at low level. Then, when the input electric potential to the node A becomes an electric potential lower than the determination threshold value, the output electric potential from the node B becomes at high level. The waveform shaping portion 210 to be used is, for example, an inverter circuit. While FIG. 4 illustrates an example in which one inverter is used as the waveform shaping portion 210, a circuit having a plurality of inverters connected in series can be used or another type of circuit having a waveform shaping effect can be used.

FIGS. 5A to 5C are diagrams schematically illustrating a relationship between the electric potential of the node A, the electric potential of the node B, and the output signal. In the first exemplary embodiment, in a case where the control signal is at high level, the drive voltage VH enters into the state of being unlikely to be supplied to the APD 201, and, in a case where the control signal is at low level, the drive voltage VH enters into the state of being supplied to the APD 201. The control signal being at high level means, for example, the control signal being at 1 V, and the control signal being at low level means, for example, the control signal being at 0 V. In a case where the control signal is at high level, the switch 202 is turned off, and, in case where the control signal is at low level, the switch 202 is turned on. The resistance value of the switch 202 in a case where the control signal is at high level becomes higher than the resistance value of the switch 202 in a case where the control signal is at low level. In a case where the control signal is at high level, since, even if avalanche multiplication occurs in the APD 201, the recharge operation is unlikely to be performed, the electric potential which is supplied to the APD 201 becomes an electric potential lower than or equal to the breakdown voltage of the APD 201. Accordingly, the avalanche multiplication operation in the APD 201 stops.

It is favorable that, as illustrated in FIG. 5A, the switch 202 is configured with one transistor and one transistor is used to perform both the quench operation and the recharge operation. This enables making the number of circuits smaller than that in a case where the quench operation and the recharge operation are performed by the respective different circuit elements. Particularly, in a case where each pixel includes a photon counting circuit and a signal of the SPAD is read out for each pixel, it is favorable to make the circuit area used for the switch 202 smaller to arrange the photon counting circuit. Accordingly, the advantageous effect obtained by configuring the switch 202 with one transistor becomes conspicuous.

FIG. 5B is a graph illustrating a temporal change in electric potential of the node A illustrated in FIG. 5A. FIG. 5C is a graph illustrating a temporal change in electric potential of the node B illustrated in FIG. 5A. During a period from time to t0 time t1, a voltage of “VH-VL” is applied to the APD 201 illustrated in FIG. 5A. In response to photons entering the APD 201 at time t1, avalanche multiplication occurs in the APD 201. This causes avalanche current to flow through the switch 202, so that the electric potential of the node A drops. After that, the amount of potential drop becomes larger, so that the voltage to be applied to the APD 201 becomes gradually smaller. Then, at time t2, avalanche multiplication in the APD 201 stops. This causes the electric potential of the node A not to drop beyond a given fixed value. After that, during a period from time t2 to time t3, a current which compensates for the amount of potential drop flows from the node of the electric potential VH to the node A, and, at time t3, the node A stabilizes at the original electric potential.

In the above-mentioned process, during a period in which the electric potential of the node A is lower than a given threshold value (determination threshold value), the electric potential of the node B becomes at high level. In this way, the waveform of a drop of electric potential of the node A caused by incidence of photons is shaped by the waveform shaping portion 210 and is thus output as a pulse signal to the node B. Then, the output of the node B is counted by the photon counting circuit 211, so that the count value increases by one least significant bit (LSB). This pulse signal is input to a readout portion via the photon counting circuit 211 and the signal line 113.

While it is possible to perform the quench operation and the recharge operation using the switch 202 according to avalanche multiplication in the APD 201, there is a case where, depending on timing of detection of photons, the electric charge generated by the APD 201 is not determined to be an output signal. For example, suppose that, as avalanche multiplication occurs in the APD 201, the node A becomes at low level and, thus, the recharge operation is being performed. Generally, the determination threshold value for the waveform shaping portion 210 is set to an electric potential higher than the electric potential difference with which avalanche multiplication occurs in the APD 201. When photons enter the APD 201 in a case where the electric potential of the node A is lower than the determination threshold value due to the recharge operation and is an electric potential at which avalanche multiplication is possible in the APD 201, avalanche multiplication occurs in the APD 201, so that the voltage of the node A becomes lower. Thus, since the electric potential of the node A becomes lower at the voltage lower than the determination threshold value, a change in electric potential across the determination threshold value does not occur and the output electric potential from the node B does not change. Accordingly, regardless of avalanche multiplication being occurring, the detected photons become not determined as a signal. Particularly, under high illumination, since photons serially enter the APD 201 for a short period, the incident light becomes unlikely to be determined as a signal. This causes, regardless of high illumination, the number of actually entering photons and the actually output signal to easily become detached from each other.

To deal with this issue, applying the control signal to the switch 202 to switch between the on-state and off-state of the switch 202 enables determining even photons which serially enter the APD 201 for a short period as a signal. Accordingly, it is favorable that the control signal is a pulse signal with a repetitive period. In other words, it is favorable that, in the configuration illustrated in FIGS. 5A to 5C, turning-on and turning-off of the switch 202 are switched at a predetermined clock frequency.

Furthermore, the advantageous effect of being able to acquire event information and luminance information in the first exemplary embodiment is obtainable even if the pulse signal is not a signal with a repetitive period. Accordingly, the pulse signal does not need to be a signal with a repetitive period. Moreover, a switch different from the switch 202 can be arranged between the switch 202 and the cathode terminal of the APD 201, and an electric potential difference of the APD 201 can be switched with use of the switch different from the switch 202. In this case, it is favorable to supply a control signal generated by the signal generation portion to the switch different from the switch 202. Moreover, the switch 202 can be configured with a resistor instead of a transistor and the APD 201 and the electric potential VH can be connected to the resistor.

The photon counting circuit 211 illustrated in FIG. 4 counts the number of photons which have entered the APD 201 within a predetermined exposure period. With regard to the configuration illustrated in FIG. 4, the photon counting circuit 211 counts a pulse signal output from the waveform shaping portion 210 and then retains the obtained count value. Moreover, in response to a control pulse signal being supplied via the drive line, the configuration illustrated in FIG. 4 is able to reset a signal retained in the photon counting circuit 211.

The memory 213 is configured to be connected to the photon counting circuit 211 and retain a counting value output from the photon counting circuit 211. A digital value is retained in the memory 213. For example, a digital memory with a bit number of 2 or more can be used as the memory 213. It is favorable to use a digital memory with a bit number of several bits or several tens of bits as the memory 213. The bit number of the memory 213 and the bit number of the photon counting circuit 211 can be equal to each other, and the bit number of the memory 213 can be larger than the bit number of the photon counting circuit 211.

The switch (first switch) 212, which switches between conduction and nonconduction between the photon counting circuit 211 and the memory 213, is connected between the photon counting circuit 211 and the memory 213. The switch 212 can be configured with, for example, a metal-oxide semiconductor (MOS) transistor. The switch 212 is able to switch between connection and disconnection according to a detection signal output from the processing circuit 215 described below.

The comparison circuit 214 is connected to the photon counting circuit 211 and the memory 213. Specifically, the comparison circuit 214 is connected to the photon counting circuit 211 and the memory 213 in such a manner that a first signal output from the photon counting circuit 211 and a second signal output from the memory 213 are input to the comparison circuit 214.

The comparison circuit 214 makes a comparison between the first signal and the second signal and outputs a result of the comparison. The first signal is a digital signal retained in the photon counting circuit 211, and the second signal is a digital signal retained in the memory 213.

The first signal is, for example, a signal obtained by performing counting during a first period. Moreover, the second signal is, for example, a signal obtained by performing counting during a second period which does not overlap the first period. The second period is, for example, a period of the n-th frame, and the first period is a period of the (n+m)-th frame (m being an integer of 1 or more) different from the period of the n-th frame. One frame is able to be defined by a cycle with which to output luminance information. From another point of view, one frame can be defined such that the timing at which a vertical synchronization signal which is output from a vertical scanning circuit transitions from high level to low level is the end timing of a preceding frame period and represents the start timing of a next frame period.

The processing circuit 215 is connected to the comparison circuit 214. The processing circuit 215 outputs, as an event signal, a detection signal corresponding to the result of comparison output from the comparison circuit 214. The detection signal is, for example, a binary signal. Moreover, the processing circuit 215 can also be configured to output a three-or-more valued signal as the detection signal.

For example, in a case where a difference between a signal retained in the photon counting circuit 211 and a signal retained in the memory 213 exceeds a predetermined threshold value, the processing circuit 215 outputs a signal indicating that there has been event information.

First, a case where the comparison circuit 214 or the processing circuit 215 has a negative bit is described. In this case, the predetermined threshold value is an absolute value, and, in a case where the predetermined threshold value is set to 5, ±5 becomes the predetermined threshold value. In this case, when a difference between the first signal, which is a signal retained in the photon counting circuit 211, and the second signal, which is a signal retained in the memory 213, is within the range of −5 to 5, the processing circuit 215 performs processing to determine that there has not been event information. Moreover, when the difference between the first signal and the second signal exceeds −5, i.e., is less than −5, and when the difference between the first signal and the second signal exceeds 5, the processing circuit 215 performs processing to determine that there has been event information.

For example, in a case where a value obtained by subtracting the first signal, which is a signal retained in the photon counting circuit 211, from the second signal, which is a signal retained in the memory 213, exceeds 5, it follows that the output for the (n+m)-th frame is smaller than the output for the n-th frame. In this case, the processing circuit 215 is able to detect, as event information, that a subject has disappeared between the first period and the second period, thus outputting a positive signal. Moreover, in a case where the value obtained by subtracting the first signal from the second signal exceeds −5, i.e., is less than −5, it follows that the output for the (n+m)-th frame is larger than the output for the n-th frame. In this case, the processing circuit 215 is able to detect, as event information, that a subject has been detected between the first period and the second period, thus outputting a negative signal. Moreover, in a case where the value obtained by subtracting the first signal from the second signal is within the range of −5 to 5, since a large change has not occurred between the n-th frame and the (n+m)-th frame, the processing circuit 215 is able to detect that there has not been event information.

Next, comparison processing different from the above-described comparison processing is described. In the above-described comparison processing, a negative bit is used for the comparison circuit 214 or the processing circuit 215. This is because, in a case where there is no negative bit, even if the subtraction processing is performed, it is impossible to reduce the obtained value beyond 0, so that it is impossible to obtain the accurate value. According to the following comparison processing, it becomes possible to detect the presence or absence of event information without the need to provide a negative bit for the comparison circuit 214 or the processing circuit 215. Moreover, in the following comparison processing, the predetermined threshold value does not need to be an absolute value and can be set to a predetermined positive number. For example, the predetermined threshold value is set to 5.

In a case where the value obtained by subtracting the first signal from the second signal exceeds the predetermined threshold value, it follows that the output for the (n+m)-th frame is smaller than the output for the n-th frame. In this case, the processing circuit 215 outputs negative event information. Here, the negative event information is information indicating that, for example, a subject larger in output than the background has disappeared or a subject smaller in output than the background has appeared.

Moreover, in a case where the value obtained by subtracting the second signal from the first signal exceeds the predetermined threshold value, since it follows that the output for the (n+m)-th frame is larger than the output for the n-th frame, the processing circuit 215 outputs positive event information. Here, the positive event information is information indicating that, for example, a subject larger in output than the background has appeared or a subject smaller in output than the background has disappeared. In this way, since a comparison result which is output from the comparison circuit 214 is configured to become a positive number and whether a subject has appeared or disappeared is recognized with a different route, the processing circuit 215 is also enabled to output positive event information and negative event information.

In a case where the value obtained by performing the subtraction processing does not exceed the threshold value, since it follows that no event is occurring, the processing circuit 215 does not output even information.

In this way, since the processing for subtracting the first signal from the second signal and subtracting the second signal from the first signal causes the obtained value to become a positive value in either case, it becomes possible to detect the presence or absence of event information without the need to provide a negative bit.

Furthermore, in a case where the value obtained by performing the subtraction processing does not exceed the predetermined threshold value, the processing circuit 215 can be configured to output, to the readout circuit 112, information indicating that no event is occurring.

The case where the value obtained by performing the subtraction processing does not exceed the predetermined threshold value corresponds to a case where the processing circuit 215 has not detected event information. In this case, control can also be performed to prevent a write from the photon counting circuit 211 to the memory 213 from being performed. In the first exemplary embodiment, in a case where the processing circuit 215 has detected that no event is occurring, the switch 212 is operated to disconnect the photon counting circuit 211 and the memory 213 from each other. This is because, since no event being occurring corresponds to there having been no change in luminance, the signals output from the photon counting circuit 211 and the memory 213 are almost equivalent values. In this way, controlling the write enables reducing power consumption caused by driving of circuits.

Furthermore, while, in the above description, a distinction is made between a positive event and a negative event, the method of, without making a distinction between a positive event and a negative event, outputting only information indicating that there is event information can also be employed.

In this way, according to the circuit configuration in the first exemplary embodiment, it becomes possible to output event information and luminance information from one pixel circuit. In other words, it becomes possible to output, as luminance information, a signal value detected by the APD 201 which has been used for determination of the presence or absence of event information.

A configuration in which, in a case where the output from the comparison circuit 214 does not exceed the predetermined threshold value, the memory 213 does not output a signal to an external unit can be employed. This enables further reducing power consumption.

Furthermore, the control over the switch 212 can be performed with use of not only the signal output from the processing circuit 215 but also a signal coming from a different route. For example, control can be performed in such a way as to, after disconnecting the photon counting circuit 211 and the memory 213 from each other with use of the signal output from the processing circuit 215, when detecting the presence or absence of next event occurrence, connect the photon counting circuit 211 and the memory 213 to each other based on a signal output from the control pulse generation portion 115.

A switch such as a transistor can be arranged between the switch 202 and the APD 201 or between the photoelectric conversion portion 102 and the signal processing portion 103 so as to switch electrical connection. Similarly, supplying the voltage VH or the voltage VL, which is supplied to the photoelectric conversion portion 102, can be electrically switched with use of a switch such as a transistor.

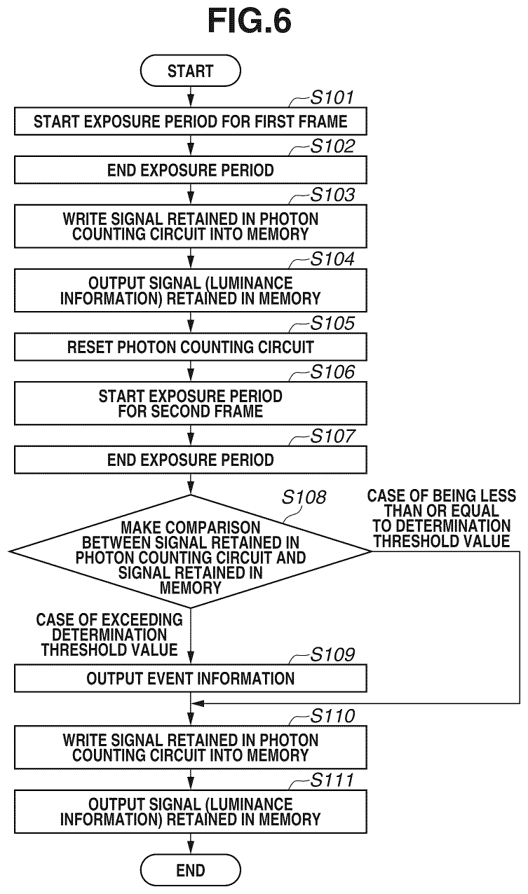

The operation flow for the photoelectric conversion device in the first exemplary embodiment is described with reference to FIG. 6. FIG. 6 illustrates the operation flow for two frames.

First, in step S101, the photoelectric conversion device starts an exposure period for the first frame.

In step S102, the photoelectric conversion device ends the exposure period for the first frame, and, in step S103, the photoelectric conversion device writes a signal retained in the photon counting circuit 211 into the memory 213.

In step S104, the photoelectric conversion device outputs a signal (luminance information) retained in the memory 213 to an external unit. Furthermore, step S104 is an optional step, and does not need to be provided.

In step S105, the photoelectric conversion device resets a signal retained in the photon counting circuit 211.

In step S106, the photoelectric conversion device starts an exposure period for the second frame.

In step S107, the photoelectric conversion device ends the exposure period for the second frame, and, in step S108, the photoelectric conversion device makes a comparison between the first signal written in the memory 213 in step S103 and the second signal retained in the photon counting circuit 211. In a case where, in step S108, a result of the comparison exceeds a predetermined threshold value (determination threshold value) (CASE OF EXCEEDING DETERMINATION THRESHOLD VALUE in step S108), then in step S109, the photoelectric conversion device outputs event information from the processing circuit 215 and then advances the processing to step S110. Moreover, in a case where, in step S108, a result of the comparison is less than or equal to the determination threshold value (CASE OF BEING LESS THAN OR EQUAL TO DETERMINATION THRESHOLD VALUE in step S108), the photoelectric conversion device advances the processing to step S110.

In step S110, the photoelectric conversion device writes a signal acquired in the second frame and retained in the photon counting circuit 211 into the memory 213.

In step S111, the photoelectric conversion device outputs a signal (luminance information) retained in the memory 213 to an external unit. Furthermore, in a case where a result of the comparison performed by the comparison circuit 214 is less than or equal to the determination threshold value, the photoelectric conversion device does not need to perform step S111.

As described above, according to the first exemplary embodiment, it becomes possible to acquire counting information and event information from the same pixel.

Moreover, there is a case where the photoelectric conversion device has the function of switching between a plurality of modes. For example, in the case of the mode which event information is to be checked, the photoelectric conversion device can operate in the above-mentioned operation flow, and, in the case of the mode which does not require checking event information but luminance information, the photoelectric conversion device can continue outputting luminance information irrespective of event information. Moreover, in the case of the mode which does not require always checking event information, the photoelectric conversion device can be configured to acquire event information by a portion outside the pixel and obtain luminance information only when having detected event information. For example, a function of detecting event information can be provided between a pixel region and the outer edge of a semiconductor layer to detect event information.

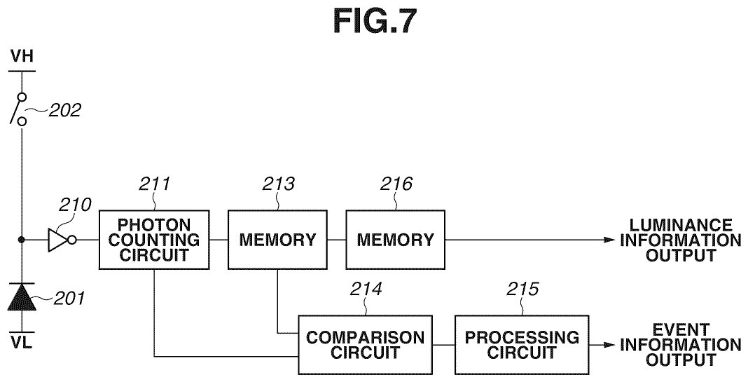

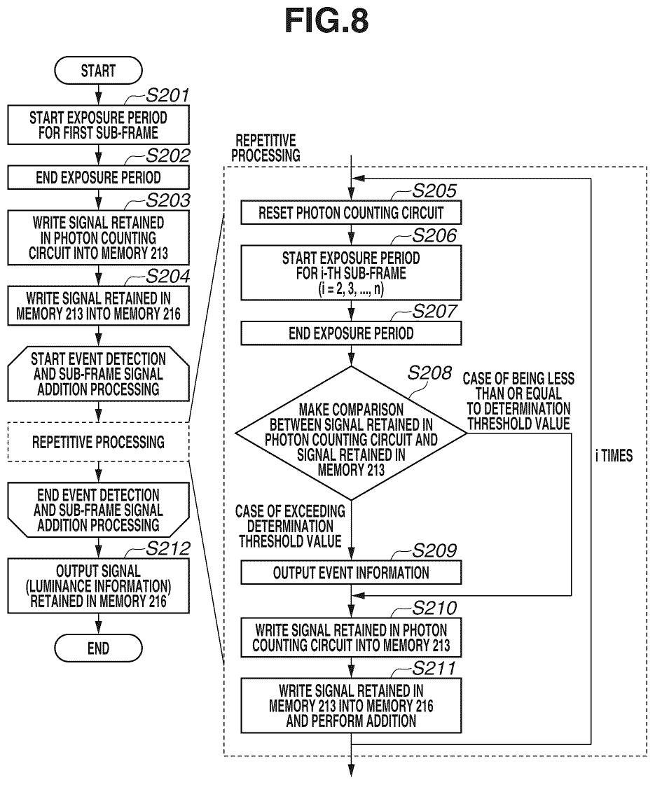

A photoelectric conversion device and an operation flow therefor in a second exemplary embodiment are described with reference to FIG. 7 and FIG. 8. The second exemplary embodiment differs from the first exemplary embodiment in that the pixel further includes a memory (second memory) 216 connected to the memory 213. Moreover, while FIG. 7 illustrates a case where the switch 212 illustrated in FIG. 4 is not provided, the switch 212 can be provided. Since the second exemplary embodiment is substantially the same as the first exemplary embodiment except for the above-mentioned issues and the issues to be described below, some descriptions may be omitted.

The memory 216 is connected to the memory 213 in such a way as to receive, as an input, a signal output from the memory 213. It is favorable that the memory 216 is a multiple-bit digital memory.

It is favorable that the bit number of the memory 216 is larger than the bit number of the photon counting circuit 211. Moreover, it is favorable that the bit number of the memory 216 is larger than the bit number of the memory 213. It is favorable that the bit number of the memory 216 is, for example, larger than or equal to three times the bit number of the memory 213. Making the bit number of the memory 216 larger than the bit number of the memory 213 enables a signal output from the memory 213 to be output after being subjected to addition at the memory 216. For example, the photon counting circuit 211 is set to 3 bits, the memory 213 is set to 3 bits, and the memory 216 is set to 14 bits. Moreover, each of the photon counting circuit 211 and the memory 213 can be set to 1 bit.

In the second exemplary embodiment, the photoelectric conversion device divides one frame into a plurality of sub-frames and performs, for each sub-frame, processing for comparison between a signal retained in the memory 213 and a signal retained in the photon counting circuit 211. For example, the photoelectric conversion device is able to count up to 3 bits for one sub-frame, sequentially output signals to the memory 216 to perform addition, and output a signal obtained by the addition from the memory 216.

Since the presence or absence of event information is able to be expressed by 1 bit, a number of bits are not required for detection of event information. On the other hand, a predetermined number or more of bits are used for detection of luminance information. According to the second exemplary embodiment, since the bit number of a circuit which properly operates even if the bit number is small is made small, it is possible to prevent or reduce the circuit size of a pixel circuit from excessively increasing.

The operation flow for the photoelectric conversion device in the second exemplary embodiment is described with reference to FIG. 8. FIG. 8 illustrates the operation flow for one frame.

First, in step S201, the photoelectric conversion device starts an exposure period for the first sub-frame.

In step S202, the photoelectric conversion device ends the exposure period for the first sub-frame, and, in step S203, the photoelectric conversion device writes a signal retained in the photon counting circuit 211 into the memory 213.

In step S204, the photoelectric conversion device writes a signal retained in the memory 213 into the memory 216.

Next, the photoelectric conversion device starts event detection and sub-frame signal addition processing. In step S205, the photoelectric conversion device resets a signal retained in the photon counting circuit 211.

In step S206, the photoelectric conversion device starts an exposure period for the second sub-frame.

In step S207, the photoelectric conversion device ends the exposure period for the second sub-frame, and, in step S208, the photoelectric conversion device makes a comparison between the first signal written in the memory 213 in step S203 and the second signal retained in the photon counting circuit 211. In a case where, in step S208, a result of the comparison exceeds a predetermined threshold value (determination threshold value) (CASE OF EXCEEDING DETERMINATION THRESHOLD VALUE in step S208), then in step S209, the photoelectric conversion device outputs event information from the processing circuit 215 and then advances the processing to step S210. Moreover, in a case where, in step S208, a result of the comparison is less than or equal to the determination threshold value (CASE OF BEING LESS THAN OR EQUAL TO DETERMINATION THRESHOLD VALUE in step S208), the photoelectric conversion device advances the processing to step S210.

In step S210, the photoelectric conversion device writes a signal acquired in the second sub-frame and retained in the photon counting circuit 211 into the memory 213.

In step S211, the photoelectric conversion device writes a signal retained in the memory 213 into the memory 216 and then performs addition processing for signals at the memory 216. Then, the photoelectric conversion device repetitively performs step S205 to step S211 i times (i being an integer of 2 or more), and then ends the event detection and sub-frame signal addition processing.

In step S212, the photoelectric conversion device outputs a signal (luminance information) retained in the memory 216 to an external unit.

As described above, even according to the second exemplary embodiment, it becomes possible to acquire counting information and event information from the same pixel.

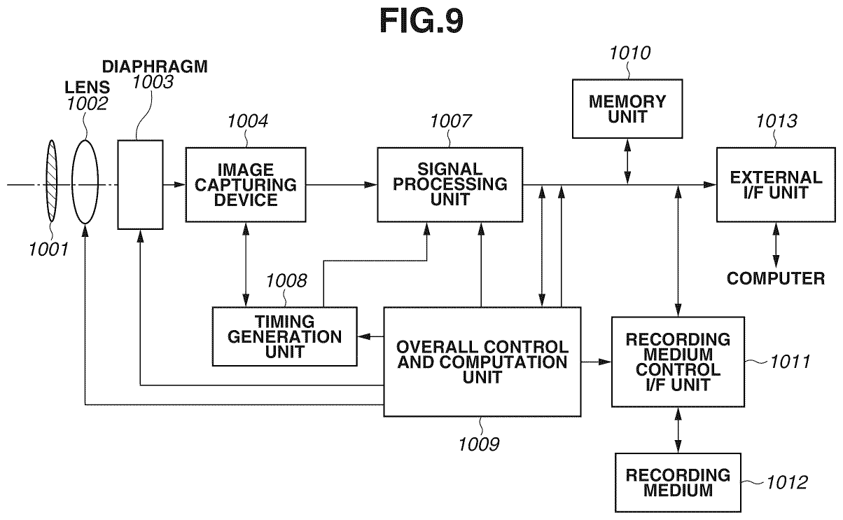

A photoelectric conversion system according to a third exemplary embodiment is described with reference to FIG. 9. FIG. 9 is a block diagram illustrating an outlie configuration of the photoelectric conversion system according to the third exemplary embodiment.

The photoelectric conversion devices described above in the first and second exemplary embodiments are applicable to various photoelectric conversion systems. Examples of the photoelectric conversion systems available for application include a digital still camera, a digital camcorder, a monitoring camera, a copying machine, a facsimile apparatus, a mobile phone, a vehicle-mounted camera, and an observation satellite. Moreover, a camera module including an optical system, such as a lens, and an image capturing device is also included in the photoelectric conversion system. FIG. 9 illustrates, by way of example, a block diagram of a digital still camera as one example of the above-mentioned apparatuses.

The photoelectric conversion system illustrated in FIG. 9 as an example includes an image capturing device 1004, a lens 1002, which forms an optical image of a subject on the image capturing device 1004, a diaphragm 1003, which makes the amount of light passing through the lens 1002 variable, and a barrier 1001, which is arranged to protect the lens 1002. The lens 1002 and the diaphragm 1003 are an optical system for collecting light onto the image capturing device 1004. The image capturing device 1004, which is a photoelectric conversion device in any one of the above-described exemplary embodiments, converts an optical image formed by the lens 1002 into an electrical signal.

The photoelectric conversion system further includes a signal processing unit 1007 serving as an image generation unit which generates an image by performing processing of an output signal output from the image capturing device 1004. The signal processing unit 1007 performs an operation of performing various types of correction and compression as needed to output image data. The signal processing unit 1007 can be formed in a semiconductor substrate in which the image capturing device 1004 is provided, or can be formed in a semiconductor substrate different from the semiconductor substrate in which the image capturing device 1004 is provided. Moreover, the image capturing device 1004 and the signal processing unit 1007 can be formed in the same semiconductor substrate.

The photoelectric conversion system further includes a memory unit 1010, which is arranged to temporarily store image data, and an external interface unit (external I/F unit) 1013, which is arranged to perform communication with, for example, an external computer. The photoelectric conversion system further includes a recording medium 1012 such as a semiconductor memory, which is arranged to perform recording or read-out of captured image data, and a recording medium control interface unit (recording medium control I/F unit) 1011, which is arranged to perform recording or read-out on the recording medium 1012. Furthermore, the recording medium 1012 can be built in the photoelectric conversion system, or can be attachable to and detachable from the photoelectric conversion system.

The photoelectric conversion system further includes an overall control and computation unit 1009, which performs various arithmetic operations and controls the entire digital still camera, and a timing generation unit 1008, which outputs various timing signals to the image capturing device 1004 and the signal processing unit 1007. In one embodiment, timing signals can be input from an external unit, and the photoelectric conversion system includes at least the image capturing device 1004 and the signal processing unit 1007, which processes an output signal output from the image capturing device 1004.

The image capturing device 1004 outputs a captured image signal to the signal processing unit 1007. The signal processing unit 1007 performs predetermined signal processing on the captured image signal output from the image capturing device 1004, and thus outputs image data. The signal processing unit 1007 generates an image using the captured image signal.

In this way, according to the third exemplary embodiment, it is possible to implement a photoelectric conversion system to which a photoelectric conversion device (image capturing device) in any one of the above-described exemplary embodiments has been applied.

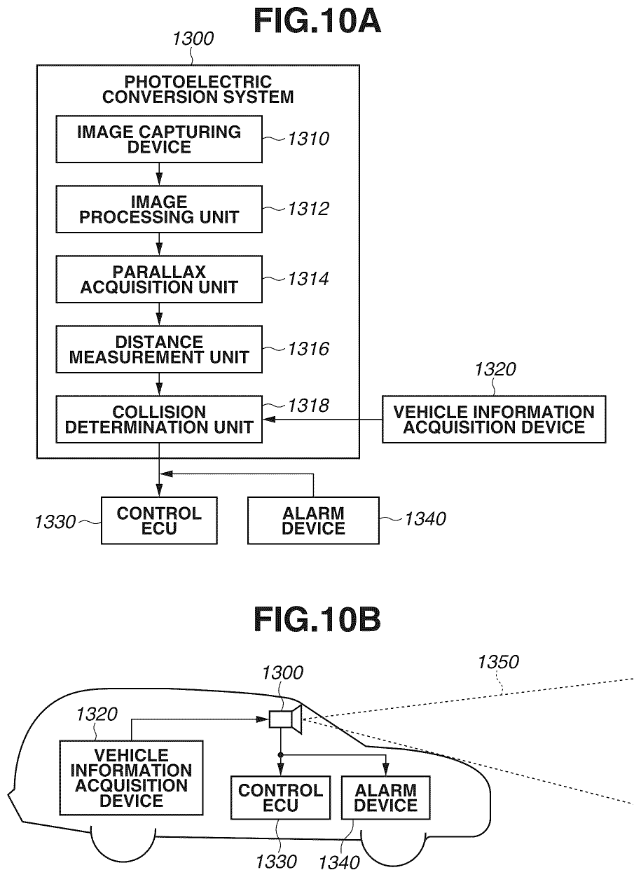

A photoelectric conversion system and a moving body according to a fourth exemplary embodiment are described with reference to FIGS. 10A and 10B. FIGS. 10A and 10B are diagrams illustrating configurations of the photoelectric conversion system and the moving body according to the fourth exemplary embodiment.

FIG. 10A illustrates an example of a photoelectric conversion system, which is associated with a vehicle-mounted camera. The photoelectric conversion system 1300 includes an image capturing device 1310. The image capturing device 1310 is any one of the photoelectric conversion devices (image capturing devices) described in the above-described exemplary embodiments. The photoelectric conversion system 1300 further includes an image processing unit 1312, which performs image processing on a plurality of pieces of image data acquired by the image capturing device 1310. Moreover, the photoelectric conversion system 1300 includes a parallax acquisition unit 1314, which calculates parallax (a phase difference between parallax images) from a plurality of pieces of image data acquired by the photoelectric conversion system 1300. Moreover, the photoelectric conversion system 1300 further includes a distance measurement unit 1316, which calculates a distance from the photoelectric conversion system 1300 to a target object based on the calculated parallax, and a collision determination unit 1318, which determines whether there is a collision possibility based on the calculated distance. Here, the distance measurement unit 1316 can acquire distance information on a distance from the photoelectric conversion system 1300 to a target object with use of Time of Flight (ToF) information, or can acquire the distance information with use of, for example, parallax information. Thus, the distance information is information about, for example, ToF, parallax, defocus amount, or a distance to a target object. The collision determination unit 1318 can be configured to determine a collision possibility with use of any one of these pieces of distance information. The distance information acquisition unit can be implemented by hardware designed for exclusive use or can be implemented by a software module. Moreover, the distance information acquisition unit can be implemented by, for example, a field programmable gate array (FPGA) or an application specific integrated circuit (ASIC), or can be implemented by a combination of these.

The photoelectric conversion system 1300 is connected to a vehicle information acquisition device 1320 and is thus able to acquire vehicle information, such as vehicle speed, yaw rate, and steering angle. Moreover, the photoelectric conversion system 1300 is connected to a control electronic control unit (ECU) 1330, which is a control device (control unit) for outputting a control signal to generate braking force on a vehicle based on a result of determination by the collision determination unit 1318. Moreover, the photoelectric conversion system 1300 is also connected to an alarm device 1340, which alarms a driver based on a result of determination by the collision determination unit 1318. For example, in a case where the collision possibility is high as a result of determination by the collision determination unit 1318, the control ECU 1330 performs vehicle control to avoid a collision and reduce damage by, for example, applying the brakes, returning an accelerator pedal, or reducing engine output. The alarm device 1340 issues a warning to a user by, for example, sounding an alarm such as sound, displaying alarm information on a screen of, for example, a car navigation system, or applying a vibration to a shoulder harness or a steering wheel.

In the fourth exemplary embodiment, the photoelectric conversion system 1300 captures an image of the surroundings of a vehicle, such as a view in front of or behind the vehicle. FIG. 10B illustrates the photoelectric conversion system 1300, which is used to capture an image of the view in front of the vehicle (an image capturing range 1350). The vehicle information acquisition device 1320 issues an instruction to cause the photoelectric conversion system 1300 or the image capturing device 1310 to perform a predetermined operation. This configuration enables further improving the accuracy of distance measurement.

While, in the above description, the present exemplary embodiment is applied to an example of a control operation for preventing collision with another vehicle, the present exemplary embodiment is also applicable to, for example, a control operation for performing autonomous driving to follow another vehicle or a control operation for performing autonomous driving to keep the lane. Moreover, the photoelectric conversion system can be applied to not only a vehicle such as a car but also a moving body (a moving apparatus), such as a ship or boat, an airplane, or an industrial robot. Such a moving body includes one of or both a drive force generation unit, which generates drive force mainly used for movement of the moving body, and a rotating body, which is mainly used for movement of the moving body. The drive force generation unit can be, for example, an engine or a motor. The rotating body can be, for example, a tire, a wheel, a screw for ship or boat, or a propeller for flight vehicle. Additionally, the photoelectric conversion system can be applied to not only the moving body but also an equipment which widely uses object recognition, such as an intelligent transport system (ITS).

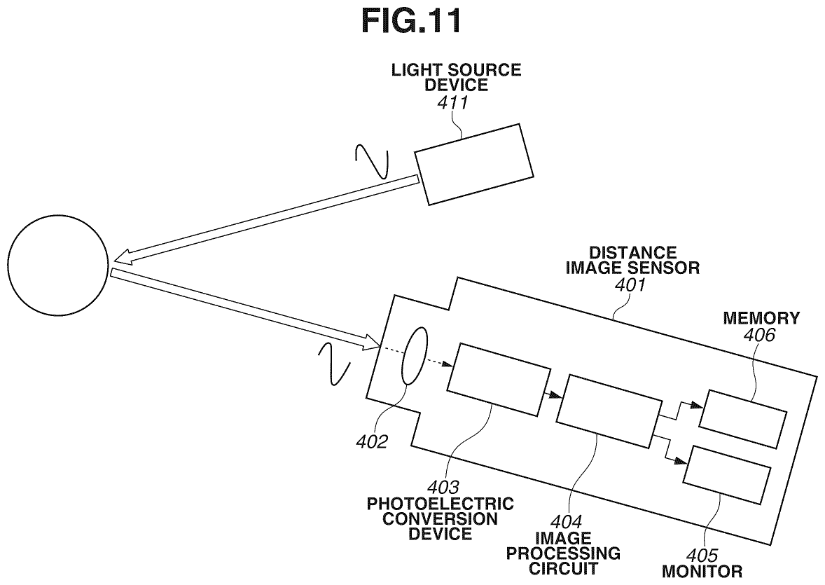

A photoelectric conversion system according to a fifth exemplary embodiment is described with reference to FIG. 11. FIG. 11 is a block diagram illustrating a configuration example of a distance image sensor 401, which is a photoelectric conversion system according to the fifth exemplary embodiment.

As illustrated in FIG. 11, the distance image sensor 401 is configured to include an optical system 402, a photoelectric conversion device 403, an image processing circuit 404, a monitor 405, and a memory 406. Then, the distance image sensor 401 is able to acquire a distance image corresponding to a distance from the distance image sensor 401 to a subject by receiving light projected by a light source device 411 onto the subject and then reflected from the surface of the subject (modulated light or pulsed light).

The optical system 402, which is configured to include one or a plurality of lenses, guides image light (incident light) from a subject to the photoelectric conversion device 403 and forms an image of the image light on the light receiving surface (sensor portion) of the photoelectric conversion device 403.

A photoelectric conversion device described in any one of the above-described exemplary embodiments is applied as the photoelectric conversion device 403, and a distance signal indicating a distance obtained from a received light signal output from the photoelectric conversion device 403 is supplied to the image processing circuit 404.

The image processing circuit 404 performs image processing for constructing a distance image based on the distance signal supplied from the photoelectric conversion device 403. Then, the distance image (image data), which has been obtained by such image processing, is supplied to and displayed on the monitor 405 or is supplied to and stored (recorded) in the memory 406.

In the distance image sensor 401 configured in this way, applying the above-described photoelectric conversion device enables, for example, acquiring a more accurate distance image in association with an improvement in characteristics of pixels.

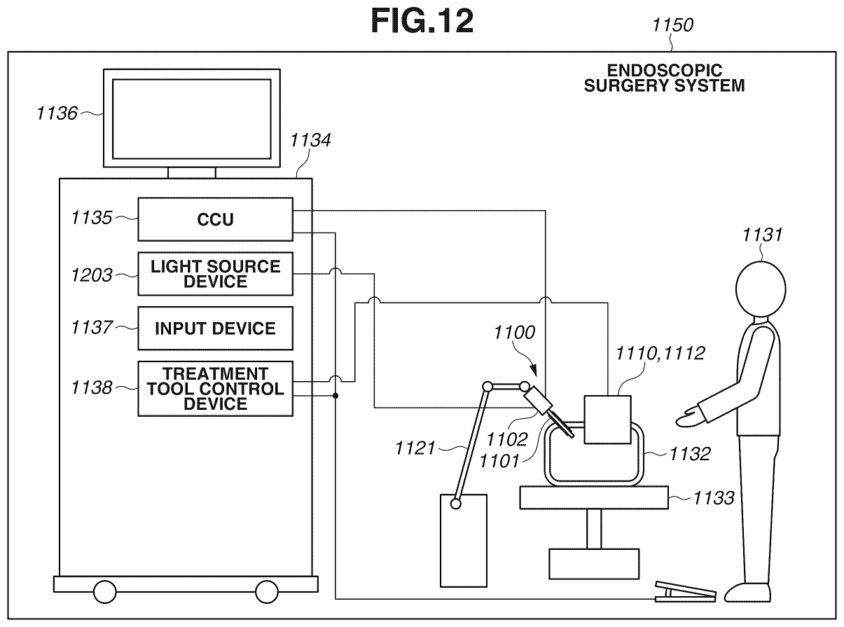

A photoelectric conversion system according to a sixth exemplary embodiment is described with reference to FIG. 12. FIG. 12 is a diagram illustrating an example of an outline configuration of an endoscopic surgery system, which is a photoelectric conversion system according to the sixth exemplary embodiment.

FIG. 12 illustrates a condition in which an operator (doctor) 1131 is performing an operation on a patient 1132 lying on a patient bed 1133 with use of an endoscopic surgery system 1150. As illustrated in FIG. 12, the endoscopic surgery system 1150 includes an endoscope 1100, a surgical instrument 1110, and a cart 1134, in which various devices for endoscopic surgery are mounted.

The endoscope 1100 includes a lens tube 1101, a region of which with a predetermined length from the tip thereof is configured to be inserted into a body cavity of the patient 1132, and a camera head 1102, which is connected to the base end of the lens tube 1101. While, in the example illustrated in FIG. 12, an endoscope 1100 configured as what is called a rigid endoscope having a rigid lens tube 1101 is illustrated, the endoscope 1100 can be configured as what is called a flexible endoscope having a flexible lens tube.

An opening portion in which an objective lens is fitted is provided at the tip of the lens tube 1101. A light source device 1203 is connected to the endoscope 1100, and light generated by the light source device 1203 is guided to the tip of the lens tube 1101 by a light guide mounted to extend inside the lens tube 1101, and is then radiated toward an observation object in the body cavity of the patient 1132 via the objective lens. Furthermore, the endoscope 1100 can be a direct-viewing endoscope or can be an oblique-viewing endoscope or a side-viewing endoscope.

An optical system and a photoelectric conversion device are provided inside the camera head 1102, and reflected light from an observation object (observation light) is focused on the photoelectric conversion device by the optical system. The observation light is photoelectrically converted by the photoelectric conversion device, so that an electrical signal corresponding to the observation light, i.e., an image signal corresponding to an observation image, is generated. The photoelectric conversion device to be used here includes a photoelectric conversion device (image capturing device) described in any one of the above-described exemplary embodiments. The generated image signal is transmitted as raw data to a camera control unit (CCU) 1135.

The CCU 1135 is configured with, for example, a central processing unit (CPU) or a graphics processing unit (GPU), and comprehensively controls operations of the endoscope 1100 and a display device 1136. Additionally, the CCU 1135 receives an image signal from the camera head 1102 and performs, on the received image signal, various types of image processing for displaying an image that is based on the image signal, such as development processing (demosaicing processing).

The display device 1136 is controlled by the CCU 1135 to display an image that is based on an image signal subjected to image processing by the CCU 1135.

The light source device 1203 is configured with a light source such as a light-emitting diode (LED), and supplies, to the endoscope 1100, irradiation light used for performing image capturing of, for example, a surgical site.

An input device 1137 is an interface for the endoscopic surgery system 1150. The user is allowed to perform inputting of various pieces of information and inputting of instructions to the endoscopic surgery system 1150 via the input device 1137.

A treatment tool control device 1138 controls driving of an energy treatment tool 1112, which is used for, for example, cauterization or incision of a tissue or sealing of a blood vessel.

The light source device 1203, which supplies, to the endoscope 1100, irradiation light used for performing image capturing of a surgical site, can be configured with, for example, a white light source configured with an LED, a laser light source, a group of LEDs of a plurality of colors, or a group of lasers of a plurality of colors. In a case where the white light source is configured with a combination of red-green-blue (RGB) laser light sources, since the output density and output timing of each color (each wavelength) is able to be controlled with a high degree of accuracy, the light source device 1203 is able to be operated to adjust white balance of a captured image. Moreover, in this case, respective images corresponding to R, G, and B are also able to be captured in a time-division manner by radiating laser beams output from respective RGB laser light sources onto an observation object in a time-division manner and controlling driving of an image sensor of the camera head 1102 in synchronization with such radiation timing. According to this method, a color image is able to be obtained without a color filter being provided in the image sensor.

Moreover, driving of the light source device 1203 can be controlled in such a way as to change the intensity of light to be output at intervals of a predetermined time. Acquiring images in a time-division manner by controlling driving of the image sensor of the camera head 1102 in synchronization with such timing of changes of the intensity of light and then combining the images enables generating a high dynamic range image without what are called a loss of shadow detail and a loss of highlight detail.

Moreover, the light source device 1203 can be configured to be able to supply light with a predetermined wavelength band corresponding to special light observation. The special light observation uses, for example, a wavelength dependence of absorption of light in a body tissue. Specifically, image capturing of a predetermined tissue such as a blood vessel of a superficial portion of the mucous membrane is performed with a high contrast by radiating light with a band narrower than that of irradiation light used at the time of ordinary observation (i.e., white light).

Alternatively, in the special light observation, fluorescent observation, which obtains an image by fluorescence generated by radiating excitation light, can be performed. In the fluorescent observation, for example, it is possible to radiate excitation light onto a body tissue and then observe fluorescence coming from the body tissue or to locally inject a reagent such as indocyanine green (ICG) into a body tissue, radiate excitation light corresponding to a fluorescence wavelength of the reagent onto the body tissue, and then obtain a fluorescent image. The light source device 1203 can be configured to be able to supply narrow-band light and/or excitation light corresponding to such special light observation.

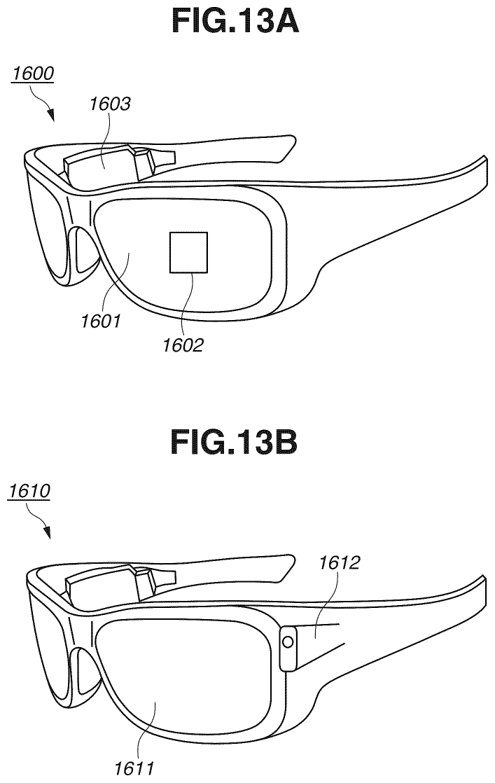

A photoelectric conversion system according to a seventh exemplary embodiment is described with reference to FIGS. 13A and 13B. FIG. 13A is a diagram illustrating an example of a configuration of eyeglasses 1600 (smartglasses), which is the photoelectric conversion system according to the seventh exemplary embodiment. The eyeglasses 1600 include a photoelectric conversion device 1602. The photoelectric conversion device 1602 is a photoelectric conversion device (image capturing device) described in any one of the above-described exemplary embodiments. Moreover, a display device including a light emitting device, such as an organic light-emitting diode (OLED) or a light-emitting diode (LED) can be mounted on the reverse surface side of a lens 1601. In one embodiment, one photoelectric conversion device 1602 can be mounted or a plurality of photoelectric conversion devices 1602 can be mounted. Moreover, a plurality of types of photoelectric conversion devices can be mounted in combination. The location of the photoelectric conversion device 1602 is not limited to that illustrated in FIG. 13A.

The eyeglasses 1600 further include a control device 1603. The control device 1603 functions as a power source which supplies electric power to the photoelectric conversion device 1602 and the above-mentioned display device. Moreover, the control device 1603 controls operations of the photoelectric conversion device 1602 and the display device. An optical system for focusing light onto the photoelectric conversion device 1602 is formed in the lens 1601.

FIG. 13B illustrates eyeglasses 1610 (smartglasses), which are another example of a photoelectric conversion system according to the seventh exemplary embodiment. The eyeglasses 1610 include a control device 1612, and a photoelectric conversion device, which is equivalent to the photoelectric conversion device 1602, and a display device are mounted in the control device 1612. The photoelectric conversion device included in the control device 1612 and an optical system for projecting light emitted from the display device are formed in a lens 1611, so that an image is projected onto the lens 1611. The control device 1612 functions as a power source which supplies electric power to the photoelectric conversion device and the display device, and controls operations of the photoelectric conversion device and the display device. The control device 1612 can include a line-of-sight detection unit, which detects the line of sight of a person wearing the eyeglasses 1610 (user). Detection of a line of sight can be performed with use of infrared (infrared light). An infrared emission unit emits infrared light to the eyeball of a user who gazes at a displayed image. Reflected light from the eyeball out of the emitted infrared light is detected by an image capturing unit including a light receiving element, so that a captured image of the eyeball is obtained. A reducing unit for reducing light traveling from the infrared emission unit to the display unit in planar view is provided, so that a decrease in the quality of an image is reduced.

A line of sight of the user on the displayed image is detected based on a captured image of the eyeball obtained by image capturing of infrared light. An optional known method can be used for line-of-sight detection using a captured image of the eyeball. For example, a line-of-sight detection method that is based on a Purkinje image formed by reflection of radiated light on the cornea can be used.

More specifically, line-of-sight detection that is based on a pupil and cornea reflection method is performed. A line-of-sight vector representing the orientation (rotational angle) of the eyeball is calculated with use of the pupil and cornea reflection method based on an image of the pupil and a Purkinje image included in the captured image of the eyeball, so that a line of sight of the user is detected.

The display device in the seventh exemplary embodiment can include a photoelectric conversion device including a light receiving element, and a displayed image on the display device can be controlled based on line-of-sight information about the user input from the photoelectric conversion device.

Specifically, in the display device, a first field-of-view region, at which the user gazes, and a second field-of-view region, which is other than the first field-of-view region, are determined based on the line-of-sight information. The first field-of-view region and the second field-of-view region can be determined by a control device for the display device or can be the ones determined by and received from an external control device. In a display region of the display device, the display resolution of the first field-of-view region can be controlled to be higher than the display resolution of the second field-of-view region. Thus, the display resolution of the second field-of-view region can be set lower than the display resolution of the first field-of-view region.

Moreover, the display region can include a first display region and a second display region different from the first display region, and a region higher in priority can be determined out of the first display region and the second display region based on the line-of-sight information. The first display region and the second display region can be determined by a control device for the display device or can be the ones determined by and received from an external control device. The resolution of a region higher in priority can be controlled to be higher than the resolution of a region other than the region higher in priority. Thus, the resolution of a region relatively low in priority can be set low.

Furthermore, determination of the first field-of-view region or the region higher in priority can be performed with use of artificial intelligence (AI). AI can be a model configured to set an image of the eyeball and a direction at which the eyeball in the image actually looks as training data and estimate the angle of a line of sight and a distance to an object pointed by the line of sight based on the image of the eyeball. An AI program can be included in a display device, can be included in a photoelectric conversion device, or can be included in an external device. In a case where the AI program is included in the external device, the AI program is transmitted to the display device via communication.

In the case of performing display control based on line-of-sight detection, the seventh exemplary embodiment can be favorably applied to smartglasses including a photoelectric conversion device which performs image capturing of an outside. The smartglasses are able to display captured external information in real time.

The above-described photoelectric conversion device and photoelectric conversion system can also be applied to, for example, an electronic apparatus such as what is called a smartphone or a tablet.

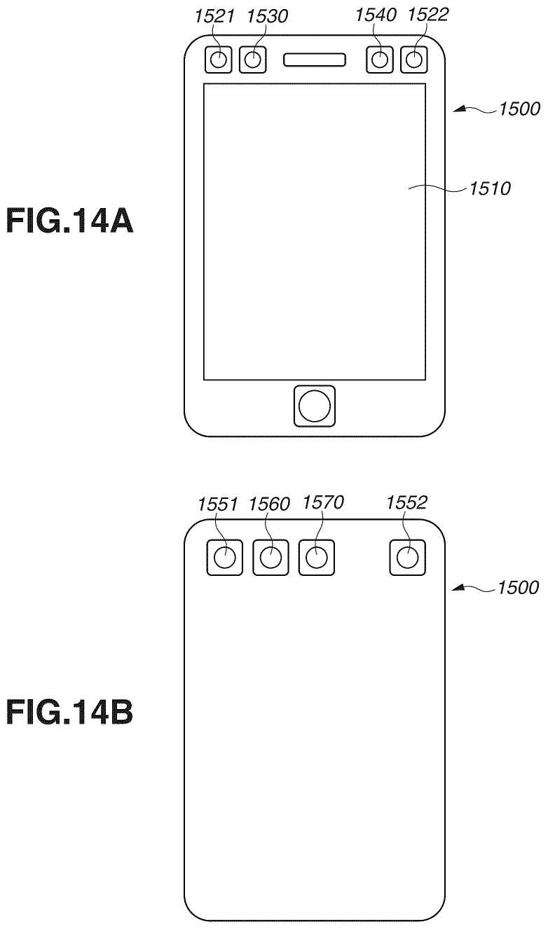

FIGS. 14A and 14B are diagrams illustrating an example of an electronic apparatus 1500 in which a photoelectric conversion device is mounted according to an eighth exemplary embodiment. FIG. 14A illustrates the front surface side of the electronic apparatus 1500, and FIG. 14B illustrates the rear surface side of the electronic apparatus 1500.

As illustrated in FIG. 14A, a display 1510, which displays an image, is arranged at the central portion of the front surface of the electronic apparatus 1500. Moreover, along the upper side of the front surface of the electronic apparatus 1500, front cameras 1521 and 1522, for each of which a photoelectric conversion device is used, an infrared (IR) light source 1530, which emits infrared light, and a visible light source 1540, which emits visible light, are arranged.

Moreover, as illustrated in FIG. 14B, along the upper side of the rear surface of the electronic apparatus 1500, rear cameras 1551 and 1552, for each of which a photoelectric conversion device is used, an IR light source 1560, which emits infrared light, and a visible light source 1570, which emits visible light, are arranged.

In the electronic apparatus 1500 configured in this way, applying the above-described photoelectric conversion device thereto enables, for example, capturing an image with a higher definition. Furthermore, the photoelectric conversion device can be applied to another electronic apparatus such as an infrared sensor, a distance measuring sensor using an infrared light source, a security camera, or a personal authentication or biometric authentication camera. This enables attaining an improvement in, for example, the accuracy or performance of such an electronic apparatus.

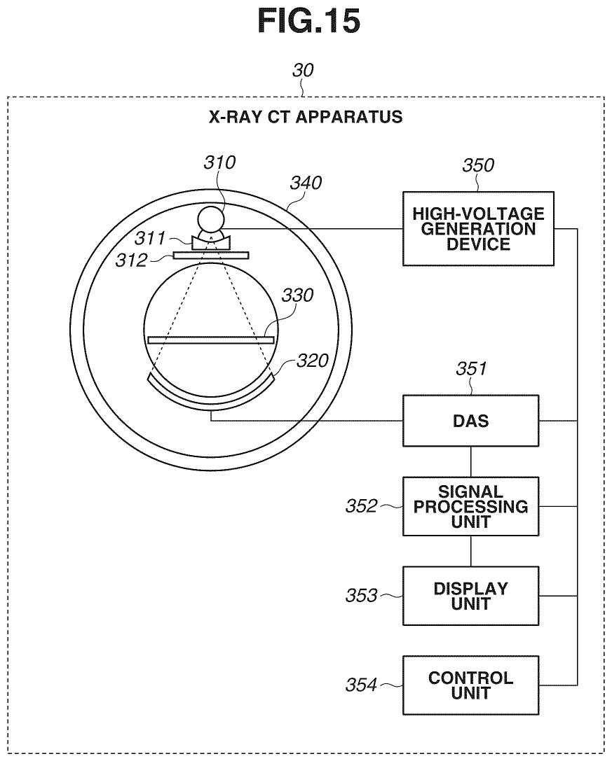

FIG. 15 is a block diagram of an X-ray computed tomography (CT) apparatus according to a ninth exemplary embodiment. The photoelectric conversion device described in the first and second exemplary embodiments can be applied to a detector included in the X-ray CT apparatus. The X-ray CT apparatus 30 in the ninth exemplary embodiment includes an X-ray generation unit 310, a wedge 311, a collimator 312, and an X-ray detection unit 320. Additionally, the X-ray CT apparatus 30 includes a top board 330, a rotary frame 340, a high-voltage generation device 350, a data acquisition system (DAS) 351, a signal processing unit 352, a display unit 353, and a control unit 354.

The X-ray generation unit 310 is configured with, for example, a vacuum tube which generates X-rays. A high voltage and a filament current output from the high-voltage generation device 350 are supplied to the vacuum tube of the X-ray generation unit 310. In response to thermoelectrons being radiated from the anode (filament) toward the anode (target), X-rays are generated.

The wedge 311 is a filter which adjusts the quantity of X-rays radiated from the X-ray generation unit 310. The wedge 311 attenuates the quantity of X-rays in such a manner that X-rays radiated from the X-ray generation unit 310 to a subject (examinee) come to have a previously determined distribution. The collimator 312 is configured with, for example, a lead plate which narrows the radiation range of X-rays having passed through the wedge 311. X-rays generated by the X-ray generation unit 310 are shaped into a cone beam form via the collimator 312, and are then radiated to the subject lying on the top board 330.

The X-ray detection unit 320 is configured with use of a photoelectric conversion device in the above-described first and second exemplary embodiments. The X-ray detection unit 320 detects X-rays generated by the X-ray generation unit 310 and having passed through the subject, and outputs a signal corresponding to the detected quantity of X-rays to the DAS 351.

The rotary frame 340 is formed in an annular shape and is configured to be rotatable. Inside the rotary frame 340, the X-ray generation unit 310 (the wedge 311 and the collimator 312) and the X-ray detection unit 320 are arranged opposite each other. The X-ray generation unit 310 and the X-ray detection unit 320 are rotatable together with the rotary frame 340.

The high-voltage generation device 350, which includes a booster circuit, generates a high voltage to be applied to the X-ray generation unit 310. The DAS 351, which includes an amplifier circuit and an analog-to-digital (A/D) conversion circuit, converts a signal received from the X-ray detection unit 320 into digital data and outputs the digital data to the signal processing unit 352.

The signal processing unit 352, which includes a central processing unit (CPU), a read-only memory (ROM), and a random access memory (RAM), is able to perform, for example, image processing in digital data. The display unit 353, which includes, for example, a planar display device, is able to display an X-ray image. The control unit 354, which includes, for example, a CPU, a ROM, and a RAM, controls the overall operation of the X-ray CT apparatus 30.

While, in the above-described exemplary embodiments, the configuration of a stacked sensor in which a first substrate and a second substrate are stacked on each other has been used as an example for description, the configuration to be used is not limited to this example. Thus, a configuration in which all of the members illustrated in FIG. 3 are arranged in one substrate can be used. Even in this case, it is possible to obtain the advantageous effect in exemplary embodiments of being able to reduce a transmission delay of the transmission signal VR.

In the present specification, there is a case of using an expression such as “A or B”, “at least one of A and B”, “at least one of A or/and B”, or “one or more of A or/and B”. This case can include, unless particularly expressly defined, all of the combinations of recited particulars. Thus, it is understandable that the above-mentioned expression discloses all of the cases encompassing a case of including at least one A, a case of including at least one B, and a case of including both at least one A and at least one B. This applies equally to a combination of three or more elements.

The above-described exemplary embodiments can be modified or altered as appropriate within a range which does not depart from the technical idea. Furthermore, the disclosure content of the present specification includes not only contents described in the present specification but also all of the particulars derivable from the present specification and the drawings accompanied by the present specification. Moreover, the disclosure content of the present specification includes the complement of a concept described in the present specification. Thus, if, in the present specification, for example, there is a description indicating that “A is larger than B”, even if a description indicating that “A is not larger than B” is omitted, it can be said that the present specification also discloses that “A is not larger than B”. This is because, in a case where there is a description indicating that “A is larger than B”, it is premised that a case where “A is not larger than B” is taken into consideration.

According to aspects of the disclosure, it is possible to provide a photoelectric conversion device capable of acquiring counting information and event information from the same pixel.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-168620 filed Sep. 28, 2023, which is hereby incorporated by reference herein in its entirety.

What is claimed is:

1. A device including a plurality of pixels, each of the plurality of pixels comprising:
an avalanche photodiode;
a counting circuit configured to count a number of photons which have entered the avalanche photodiode within an exposure period;
a first memory connected to the counting circuit;
a first switch arranged between the counting circuit and the first memory; and
a comparison circuit connected to the counting circuit and the first memory,
wherein the first switch switches between connection and disconnection between the counting circuit and the first memory according to a detection signal that is based on a signal output from the comparison circuit.

2. The device according to claim 1, wherein the comparison circuit makes a comparison between a first signal output from the counting circuit and a second signal output from the first memory.

3. The device according to claim 2,
wherein the first signal is a signal counted during a first period, and
wherein the second signal is a signal counted during a second period which does not overlap the first period.

4. The device according to claim 3, wherein the comparison between the first signal and the second signal made by the comparison circuit includes subtraction processing to be performed between the first signal and the second signal.

5. The device according to claim 1,
wherein each of the plurality of pixels further comprises a processing circuit connected to the comparison circuit, and
wherein the detection signal is a signal which is output from the processing circuit according to a result output from the comparison circuit.

6. The device according to claim 1, wherein, in a case where an output from the comparison circuit exceeds a predetermined threshold value, the first switch connects the counting circuit and the first memory to each other, so that a write operation from the counting circuit to the first memory and an output operation for luminance information from the first memory are performed.

7. The device according to claim 1, wherein, in a case where a result output from the comparison circuit is less than or equal to a predetermined threshold value, the first memory does not output a signal.

8. The device according to claim 1, wherein each of the plurality of pixels further comprises a second memory connected to the first memory.

9. The device according to claim 8, wherein a bit number of the second memory is larger than a bit number of the first memory.

10. The device according to claim 9, wherein the bit number of the second memory is a bit number exceeding three times the bit number of the first memory.

11. The device according to claim 9, wherein the second memory performs addition to a signal output from the first memory.

12. The device according to claim 11, wherein the second memory outputs, to an external unit, a signal obtained by performing addition to a signal output from the first memory.

13. The device according to claim 1,
wherein the avalanche photodiode includes a first terminal and a second terminal, and
wherein each of the plurality of pixels further comprises a second switch connected between the first terminal and a power source terminal, the second switch being configured to switch between a charge state and a non-charge state of the avalanche photodiode.

14. The device according to claim 13, wherein each of the plurality of pixels further comprises a waveform shaping portion connected between the counting circuit and the avalanche photodiode.

15. A system comprising:
the device according to claim 1; and
a processing unit configured to generate an image using a signal output from the device.

16. A moving body comprising:
the device according to claim 1; and
a control unit configured to control movement of the moving body using a signal output from the device.

17. A device including a plurality of pixels, each of the plurality of pixels comprising:
an avalanche photodiode;
a counting circuit configured to count a number of photons which have entered the avalanche photodiode within an exposure period;
a first memory connected to the counting circuit; and
a second memory connected to the first memory,
wherein a bit number of the second memory is larger than a bit number of the first memory.

18. The device according to claim 17, wherein the second memory performs addition to a signal output from the first memory and outputs a signal obtained by performing the addition.

19. The device according to claim 17, wherein the bit number of the second memory is a bit number exceeding three times the bit number of the first memory.

20. The device according to claim 18, wherein the second memory performs addition to signals of a plurality of sub-frames.

21. The device according to claim 17,
wherein each of the plurality of pixels further comprises a comparison circuit connected to the counting circuit and the first memory, and
wherein the comparison circuit makes a comparison between a first signal output from the counting circuit and a second signal output from the first memory.

22. The device according to claim 21,
wherein the first signal is a signal counted during a first period, and
wherein the second signal is a signal counted during a second period which does not overlap the first period.

23. The device according to claim 21, wherein, in a case where a result of the comparison made by the comparison circuit exceeds a predetermined threshold value, the device outputs event information, and, in a case where the result of the comparison made by the comparison circuit is less than or equal to the predetermined threshold value, the device writes a signal retained the counting circuit into the first memory.

24. The device according to claim 17,
wherein the avalanche photodiode includes a first terminal and a second terminal, and
wherein each of the plurality of pixels further comprises a first switch connected between the first terminal and a power source terminal, the first switch being configured to switch between a charge state and a non-charge state of the avalanche photodiode.

25. The device according to claim 24, wherein each of the plurality of pixels further comprises a waveform shaping portion connected between the counting circuit and the avalanche photodiode.

26. A system comprising:
the device according to claim 17; and
a processing unit configured to generate an image using a signal output from the device.

27. A moving body comprising:
the device according to claim 17; and
a control unit configured to control movement of the moving body using a signal output from the device.
